(19) United States
(12) Patent Application Publication
(10) Pub. No.: US 2026/0027912 A1
(43) Pub. Date: Jan. 29, 2026

(54) Vehicle Comprising Dual Batteries

(71) Applicants: HYUNDAI MOTOR COMPANY, Seoul (KR); KIA CORPORATION, Seoul (KR)

(72) Inventor: Soo Yang Jin, Hwaseong-si (KR)

(73) Assignees: HYUNDAI MOTOR COMPANY, Seoul (KR); KIA CORPORATION, Seoul (KR)

(21) Appl. No.: 19/012,001

(22) Filed: Jan. 7, 2025

(30) Foreign Application Priority Data
Jul. 29, 2024 (KR) 10-2024-0100099

(51) Int. Cl. B60L 15/20; B60L 7/10; B60L 50/60; B60L 58/12; B60L 58/20; B60L 58/22

(52) U.S. Cl. CPC B60L 15/2045; B60L 7/10; B60L 50/60; B60L 58/12; B60L 58/20; B60L 58/22

(57) ABSTRACT

A vehicle includes a driving unit including a motor, a first battery and a second battery provided to supply power to the driving unit, and a controller controlling the first battery and the second battery, wherein the controller controls the first battery to supply power to the driving unit in a normal driving situation in which requested output corresponding to driving is lower than or equal to a maximum output of the first battery, and controls the first battery and the second battery so that the second battery additionally supplies power to the driving unit together with the first battery in a high-output driving situation in which the requested output exceeds the maximum output of the first battery.

### CROSS-REFERENCE TO RELATED APPLICATION(S)

This application claims benefit of priority to Korean Patent Application No. 10-2024-0100099, filed on Jul. 29, 2024, in the Korean Intellectual Property Office, the disclosure of which is incorporated herein by reference in its entirety.

### TECHNICAL FIELD

The present disclosure relates to a vehicle including dual batteries.

### BACKGROUND

Electric vehicles are classified into hybrid electric vehicles (HEV), plug-in hybrid vehicles (PHEV), and pure electric vehicles (EV) depending on the degree to which the roles of electric motors and batteries are involved in the existing internal combustion engine.

Pure electric vehicles are vehicles that run (e.g., solely) on electric energy, while hybrid electric vehicles and plug-in hybrid vehicles are vehicles in which an internal combustion engine is combined with an electric motor.

Batteries provided in electric vehicles may have a high-energy density cell electrode design for a driving range or a high-output density cell electrode design for high output.

However, since the high-energy density design and the high-output density design are in a trade-off relationship from a structural perspective, there are limitations in designing a battery that may secure performance above a reference in terms of both driving range and high output.

### SUMMARY

An aspect of the present disclosure is to provide a vehicle including a dual battery capable of supplying power to a first battery of a high energy density design during normal driving and additionally supplying power to a second battery of a high output density design in a situation in which high output is useful (e.g., required).

According to an aspect of the present disclosure, a vehicle includes a driving unit including a motor, a first battery and a second battery provided to supply power to the driving unit, and a controller controlling the first battery and the second battery, wherein the controller controls the first battery to supply power to the driving unit in a normal driving situation in which requested output corresponding to driving is lower than or equal to a maximum output of the first battery, and controls the first battery and the second battery so that the second battery additionally supplies power to the driving unit together with the first battery in a high-output driving situation in which the requested output exceeds the maximum output of the first battery.

The controller may be configured to allow or limit power supply of the second battery to the driving unit based on a state of charge of the second battery in the high-output driving situation.

The controller may control the second battery to supply power to the driving unit when the state of charge of the second battery is equal to or greater than a first reference state.

The controller may restrict the supply of power from the second battery to the driving unit and provide a driver with a notification indicating that the vehicle (e.g., it) may not be able (e.g., is impossible) to respond to the requested output, when the state of charge of the second battery is lower than the first reference state.

The first battery may be configured based on a high energy density cell design, and the second battery may be configured based on a high output density cell design.

The first battery may have a higher capacity than the second battery.

The first battery may be provided to be charged using power supplied from an external source.

The first battery may be able to supply power to the second battery, and the second battery may be charged through power supplied from the first battery.

The first battery and the second battery may be provided to be charged by regenerative braking.

The controller may control one of the first battery and the second battery to be charged by regenerative braking based on the state of charge of the second battery in a regenerative braking state.

The controller may be configured to charge the second battery through regenerative braking when the state of charge of the second battery is less than the second reference state and to charge the first battery through regenerative braking when the state of charge of the second battery is equal to or greater than the second reference state.

The controller may determine whether a priority charging condition of the first battery is met when the state of charge of the second battery is less than the second reference state, and when the priority charging condition is met, the controller may be configured to charge the first battery through regenerative braking, even if the state of charge of the second battery is less than the second reference state.

A case in which the priority charging condition is met may be one of a state in which a driver sets the first battery to be charged first or a state in which a discharged capacity of the second battery is equal to or less than a reference value during a reference date.

The controller may determine whether to charge the first battery through regenerative braking based on a state of charge of the first battery when the priority charging condition is met.

The controller may be configured to charge the first battery through regenerative braking when the state of charge of the first battery is less than a third reference state and to charge the second battery through regenerative braking when the state of charge of the first battery is equal to or greater than the third reference state even if the priority charging condition is met.

### BRIEF DESCRIPTION OF DRAWINGS

This and other aspects, features, and advantages of the present disclosure will be more clearly understood from the following detailed description, taken in conjunction with the accompanying drawings, in which:

FIG. 1 illustrates a configuration diagram of a vehicle including a dual battery according to an embodiment of the present disclosure;

FIG. 2 illustrates a flowchart of a control method of a vehicle including a dual battery according to an embodiment of the present disclosure; and

FIG. 3 illustrates a flowchart of a control method of a vehicle including a dual battery according to an embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers (e.g., all) modifications, equivalents, and alternatives falling within the spirit and scope of the present disclosure.

It will be understood that, although the terms “first,” “second,” and the like may be used herein to describe various elements, these elements should not be limited by these terms. These terms are (e.g., only) used to distinguish one element from another. For example, a first element could be termed a second element, and a second element could similarly be termed a first element without departing from the scope of the present disclosure. As used herein, the term “and/or” includes (e.g., any and all) combinations of one or more of the associated listed items.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, operations, operations, elements, and/or components but do not preclude the presence or addition of one or more other features, numbers, operations, operations, elements, components, and/or groups thereof.

Unless defined in a different way, (e.g., all) the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In this specification, vehicles refer to a variety of vehicles that move transported objects, such as people, animals, or goods, from a starting point to a destination. These vehicles are not limited to vehicles that run on roads or tracks.

Hereinafter, embodiments of the present disclosure will be described with reference to the accompanying drawings.

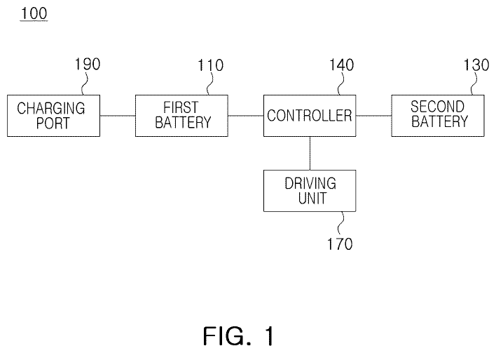

FIG. 1 illustrates a configuration diagram of a vehicle 100 including dual batteries 110 and 130 according to an embodiment of the present disclosure.

FIG. 1 is a block diagram schematically illustrating a configuration of the vehicle 100 according to an embodiment of the present disclosure. The vehicle 100 is not limited to including (e.g., only) the components illustrated in FIG. 1, and may further include other components.

The vehicle 100 according to an embodiment of the present disclosure may be an electric vehicle driven by electric energy from the batteries 110 and 130. For example, the vehicle may include a pure electric vehicle (EV) that runs solely on electric energy, a hybrid electric vehicle (HEV) in which an internal combustion engine is combined with an electric motor, and a plug-in hybrid electric vehicle (PHEV).

Referring to FIG. 1, the vehicle 100 according to an embodiment may include different types of dual batteries (e.g., a first battery 110 and a second battery 130) and may be configured to control an output and charging of the dual batteries based on a driving state of the vehicle 100 and a state of charge of the dual batteries.

The vehicle 100 according to an embodiment may include the first battery 110, the second battery 130, a controller 140, a driving unit 170, and a charging port 190.

The first battery 110 and the second battery 130 may constitute dual batteries of the vehicle 100. The first battery 110 and the second battery 130 may be electrically connected to the driving unit 170 of the vehicle 100 and may supply power to the driving unit 170.

The first battery 110 and the second battery 130 may be electrically connected to the controller 140 and may receive a control signal from the controller 140. In addition, the first battery 110 and the second battery 130 may be controlled by a control signal from the controller 140. For example, the first battery 110 and the second battery 130 may be provided so that at least one of the first battery 110 and the second battery 130 supplies power to the driving unit 170 based on the control signal.

Each of the first battery 110 and the second battery 130 may transfer battery state information to the controller 140. The battery state information may include, but is not limited to, a state of charge (SOC), voltage (e.g., open circuit voltage (OCV), and closed circuit voltage (CCV)), current, and a battery liquid temperature, and may further include various types of information related to the state of the battery.

For example, the first battery 110 may include a first battery sensor (not shown), and the first battery sensor may detect and measure state information of the first battery 110 and transmit the same to the controller 140. The second battery 130 may include a second battery sensor (not shown), and the second battery sensor may detect and measure state information of the second battery 130 and transmit the same to the controller 140.

Although not shown, the vehicle 100 may further include a plurality of load devices, and at least one of the first battery 110 and the second battery 130 may be electrically connected to the plurality of load devices and may supply power to the plurality of load devices. For example, the plurality of load devices may refer to devices mounted on the vehicle 100 and operated by power supplied from the first battery 110 or the second battery 130.

According to various embodiments, the plurality of load devices may include an electric active stabilizer, an electric power steering, an antilock brake system) (ABS)/vehicle stability control (VSC) actuator, an electronic control brake (ECB), and an electric supercharger. In addition, the plurality of load devices may include devices requiring power backup, such as a by-wire system (e.g., shift-by-wire, steer-by-wire, brake-by-wire) and/or an autonomous driving/driving assistance system (e.g., camera, millimeter wave, radar, in-vehicle communication device, door lock). However, the types of the plurality of load devices are not limited to the examples described.

The first battery 110 and the second battery 130 may be of different types of batteries. For example, the first battery 110 and the second battery 130 may have different structures. The first battery 110 may be configured through a high energy density cell design, and the second battery 130 may be configured through a high output density cell design. For example, the first battery 110 and the second battery 130 may be configured to be different in at least one of a cell design structure, output, and capacity.

The first battery 110 may be a battery (e.g., a high energy battery or a high capacity battery) having a relatively high capacity compared to the second battery 130, and the second battery 130 may be a battery (high output battery) having relatively high output compared to the first battery 110. For example, the first battery 110 may have a capacity of about 70 to 140 kWh and a maximum output of about 300 to 600 kW. The second battery 130 may have a capacity of about 5 to 10 kWh and a maximum output of about 200 to 400 kW. However, the capacity and maximum output of the first battery 110 and the second battery 130 are not limited to the aforementioned numeral values.

For example, the first battery 110 and the second battery 120 may have substantially the same overall structure including a cell, a module, and a system. However, even if the same material is applied in terms of the cell structure, the first battery 110 may have a cell design that increases electrode loading of a relatively high energy density compared to the second battery 120, and the second battery 120 may have a high output cell design. In addition, for example, the first battery 110 may have a larger size than the second battery 120.

The high energy density design is intended to secure a driving range of the vehicle 100, and the high output density design is intended to provide a high output, and the cell design for the high energy density and the high output density may be in a trade-off relationship. The vehicle 100 according to the present disclosure includes dual batteries including the first battery 110 and the second battery 130 having the cell designs configured to be different to correspond to the high energy density and the high output density, respectively, and may be controlled to use (e.g., only) the first battery 110 as a driving energy source or to use both the first battery 110 and the second battery 130 as driving energy sources depending on a driving situation.

Meanwhile, according to various embodiments, the first battery 110 and the second battery 130 may be configured as the same battery (e.g., the battery having the same cell design structure, the same output, or the same capacity).

The first battery 110 may supply power to the driving unit 170 when the vehicle 100 drives. For example, the first battery 110 may be provided to supply power to the driving unit 170 under the control of the controller 140. The vehicle 100 may basically drive by driving the driving unit 170 using power supplied from the first battery 110. The first battery 110 may operate as a basic driving source for driving the driving unit 170 in both a general driving situation of the vehicle 100 and a predetermined driving situation requiring high output, thereby supplying power to the driving unit 170.

The first battery 110 may supply power to the second battery 130. For example, the first battery 110 may be electrically connected to the second battery 130 and configured to supply power to the second battery 130 to charge the second battery 130. The first battery 110 may supply power to the second battery 130 based on a control signal from the controller 140.

The first battery 110 may be charged by power supplied from the outside. The first battery 110 may be charged by power received from the outside through the charging port 190. For example, the first battery 110 may be electrically connected to the charging port 190 to which charging power is applied from the outside, to be charged by external charging power.

The second battery 130 may supply power to the driving unit 170 in a specific situation while the vehicle 100 drives. For example, the second battery 130 may be provided to additionally supply power to the driving unit 170 under the control of the controller 140 in a driving situation in which an output exceeding the maximum output of the first battery 110 is requested. The vehicle 100 may basically use power supplied from the first battery 110, but when the requested output exceeds the maximum output of the first battery 110, the vehicle may drive by driving the driving unit 170 by additionally using power supplied from the second battery 130.

The second battery 130 may supply power to the driving unit 170 when a state of charge is equal to or higher than a reference state. For example, the second battery 130 may be controlled to not supply power to the driving unit 170 if the state of charge is below the reference state even in the case that the requested output exceeds the maximum output of the first battery 110.

The second battery 130 may be charged by the first battery 110. For example, the second battery 130 may be charged with power received from the first battery 110. The operation of charging the second battery 130 by the first battery 110 may be performed based on an input signal of a driver. For example, if the state of charge of the second battery 130 is below the reference state, a notification may be provided to a display device (e.g., a cluster or the like) provided in the vehicle 100, and the driver may charge the second battery 130 through the first battery 110 by applying an input signal to an input device provided in the vehicle 100.

According to various embodiments, the operation of charging the second battery 130 by the first battery 110 may be performed based on preset conditions regardless of the driver's input. For example, the controller 140 stores logic for determining whether to charge the second battery 130 according to the state of charge of the first battery 110, and in a case in which the second battery 130 may need (e.g., needs) to be charged and the state of charge of the first battery 110 is equal to or greater than the reference state under the control of the controller 140, the first battery 110 may be controlled to supply power to the second battery 130, and when the state of charge of the first battery 110 is less than the reference state, the first battery 110 may be controlled to not supply power to the second battery 130.

The first battery 110 and the second battery 130 may be charged by regenerative braking. For example, the first battery 110 and the second battery 130 may be provided to be charged in a regenerative braking state of the vehicle 100. The first battery 110 and the second battery 130 may be charged (e.g., preferentially) by considering their respective states of charge and priority charging conditions when the vehicle 100 regenerates.

The controller 140 may control the power output and charging of the dual batteries (the first battery 110 and the second battery 130). The controller 140 may be electrically connected to the first battery 110, the second battery 130, and the driving unit 170.

The controller 140 may store logic (e.g., necessary) for controlling the dual batteries 110 and 130 and/or the driving unit 170 to supply power of the dual batteries 110 and 130 to the driving unit 170 or to charge the dual batteries 110 and 130 and may make various determinations based on the logic to generate or transmit a control signal or command. For example, the controller 140 may transmit a signal to the driving unit 170 so that power from the first battery 110 and/or the second battery 130 is supplied, transmit a signal to the second battery 130 so that power from the first battery 110 is supplied, and may transmit a signal to the first battery 110 or the second battery 130 so that the first battery 110 or the second battery 130 is charged during regenerative braking.

The controller 140 may include a processor and a memory. Here, the processor may control the overall operation of the controller 140, and the memory may store programs for the operation of the controller 140, input/output data, and various types of setting information. The memory may be implemented as one or more storage mediums, such as flash memory, hard disk, secure digital (SD) card, random access memory (RAM), read only memory (ROM), and web storage.

The controller 140 may receive state information of the first battery 110 from the first battery 110 and may receive state information of the second battery 130 from the second battery 130. The controller 140 may control the power output and charging of the batteries 110 and 130 based on at least the state of charge of the first battery 110 and the second battery 130 among the state information of the first battery 110 and the state information of the second battery 130.

The controller 140 may determine whether requested output by the driver, while the vehicle 100 is driving exceeds the maximum output of the first battery 110, and if the requested output exceeds the maximum output of the first battery 110, the controller 140 may determine whether to additionally supply power of the second battery 130 to the driving unit 170 based on the state of charge of the second battery 130.

The controller 140 may determine that a case in which the requested output is greater than (e.g., exceeds) the maximum output of the first battery 110 is a high-output driving situation and may determine that a case in which the requested output is less than the maximum output of the first battery 110 is a normal driving situation.

The controller 140 may control the dual batteries 110 and 130 so that power of the first battery 110 is supplied to the driving unit 170 and power of the second battery 130 is not supplied to the driving unit 170 during normal driving.

When the charged capacity of the second battery is equal to or greater than a preset reference value, the controller 140 may control the second battery 130 so that power of the second battery 130 is additionally supplied to the driving unit 170.

Conversely, when the charged capacity of the second battery 130 is less than the preset reference value during high-output driving, the controller 140 may control the second battery 130 so that power of the second battery 130 is not additionally supplied to the driving unit 170 and may provide a notification indicating that it is not possible to respond to the requested output to the driver.

The controller 140 may determine which of the first battery 110 and the second battery 130 is to be charged by regenerative braking based on the state of charge of the first battery 110, the state of charge of the second battery 130, and whether the priority charging condition of the first battery is met during regenerative braking of the vehicle 100.

The controller 140 may be set to charge the second battery 130 preferentially during regenerative braking.

In the case of regenerative braking, when the charging amount of the second battery 130 is less than the preset reference value and the priority charging condition of the first battery 110 is not met, the controller 140 may control the driving unit 170 and the second battery 130 so that the second battery 130 is charged by regenerative braking.

In the case of regenerative braking, when the charged capacity of the second battery 130 is greater than or equal to the preset reference value, the controller 140 may control the driving unit 170 and the first battery 110 so that the first battery 110 is charged by the regenerative braking.

In the case of the regenerative braking, when the charged capacity of the second battery 130 is less than the preset reference value and the priority charging condition of the first battery is met, the controller 140 may control the driving unit 170 and the first battery 110 so that the first battery 110 is charged by the regenerative braking.

A case in which the priority charging condition of the first battery 110 is met may refer to a case corresponding to any one of a state in which the driver sets the first battery 110 to be charged preferentially in order to increase the driving range or a state in which the discharged amount of the second battery 130 is less than a reference value during a reference day.

For example, the controller 140 may control the first battery 110 to be charged by regenerative braking when the driver wants to charge the first battery 110 (e.g., a corresponding signal is applied through an input device provided in the vehicle 100) even if the charged capacity of the second battery 130 is less than the preset reference value. In addition, even in the case that the charged capacity of the second battery 130 is less than the preset reference value, if a discharged amount is equal to or less than a reference value due to a less use of the second battery 130 during a period from the present to a point before a predetermined reference date, the controller 140 may control the first battery 110 to be charged by regenerative braking.

In the case of the regenerative braking, even in the case that the charged capacity of the second battery is less than the preset reference value and the priority charging condition of the first battery 110 is met, if the charged capacity of the first battery 110 is sufficient, the controller 140 may control the driving unit 170 and the second battery 130 so that the second battery 130 may be charged by regenerative braking.

The driving unit 170 may provide driving power for driving the vehicle 100 using power supplied from the first battery 110 or the second battery 130. The driving unit 170 may be configured to be in charge of driving of the vehicle and perform regenerative driving at the time of braking the vehicle to charge the first battery 110 or the second battery 130.

Although not shown, the driving unit 170 may include a motor providing rotatory force to wheels of the vehicle 100 and an inverter connected between the motor and the batteries 110 and 130 to perform power conversion. For example, when the motor is driven, the inverter may convert the direct current (DC) power of the first battery 110 or the second battery 130 into alternating current (AC) power and supply the same to the motor. In addition, during regenerative braking, the inverter may operate the motor with a generator and convert current generated by the rotation of the motor into DC power and supply the same to the first battery 110 or the second battery 130.

The charging port 190 may be connected to the first battery 110. The charging port 190 may receive power for charging the first battery 110 from the outside. The charging port 190 may supply charging power applied from the outside to the first battery 110 so that the first battery 110 may be charged.

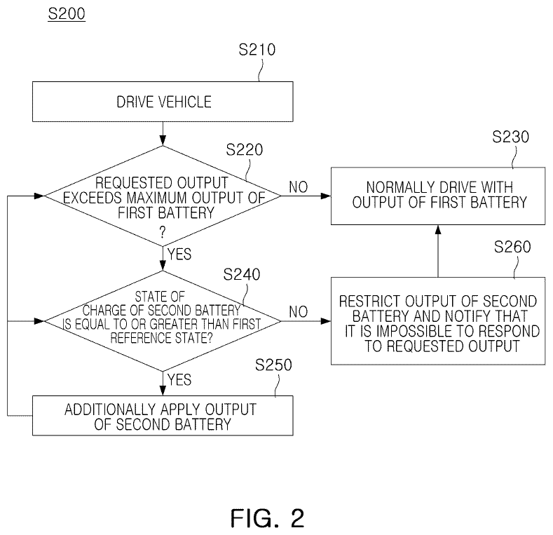

FIG. 2 is a flowchart of a control method of the vehicle 100 including dual batteries 110 and 130 according to an embodiment of the present disclosure.

FIG. 2 illustrates a method of controlling power supply of dual batteries (S200) that controls an operation in which the first battery 110 and the second battery 130 supply power to the driving unit 170 according to requested output when the vehicle 100 is driven.

The operations included in the method of controlling power supply (S200) of the dual batteries may be performed by at least some of the components (e.g., the first battery 110, the second battery 130, the controller 140, and the driving unit 170) included in the vehicle (e.g., the vehicle 100 of FIG. 1) described above with reference to FIG. 1.

Hereinafter, when describing FIG. 2, reference will be made together with FIG. 1, and redundant descriptions will be omitted.

Referring to FIG. 2, the method of controlling power supply of the dual batteries by the vehicle 100 according to an embodiment may be configured to additionally supply power of the second battery 130 to the driving unit 170 based on the output requested when the vehicle is driven and the state of charge of the second battery 130.

The controller 140 may control the first battery 110 to supply power to the driving unit 170 so that the vehicle 100 may be driven (S210).

The controller 140 may determine whether the requested output according to the driving of the vehicle exceeds the maximum output of the first battery 110 (S220).

If the requested output does not exceed the maximum output of the first battery 110, the controller 140 may determine that it is a normal driving situation, and drive the driving unit 170 (e.g., only) with power of the first battery 110 to control to maintain the normal driving situation of the vehicle 100 (S230).

If the requested output exceeds the maximum output of the first battery 110, the controller 140 may determine that it is a high-output driving situation and may determine whether the state of charge of the second battery 130 is higher than or equal to the first reference state (S240).

Here, if the state of charge of the second battery 130 is equal to or greater than the first reference state, it may mean that power of the second battery 130 is sufficient to be additionally supplied to the driving unit 170, and if the state of charge of the second battery 130 is lower than the first reference state, it may mean that it is difficult to additionally supply power of the second battery 130 to the driving unit 170.

If the state of charge of the second battery 130 is equal to or greater than the first reference state, the controller 140 may control the second battery 130 to additionally supply power to the driving unit 170 (S250).

For example, if the state of charge of the second battery 130 is sufficient to supply power, the second battery 130 may additionally supply power to the driving unit 170 by assisting the power supply of the existing first battery 110, thereby providing an output corresponding to the requested output exceeding the maximum output of the first battery 110.

When power of the second battery 130 is additionally supplied to the driving unit 170 (e.g., after S250 is performed), the controller 140 may (e.g., continuously) monitor whether the requested output exceeds the maximum output of the first battery 110 (S220) and whether the state of charge of the second battery 130 is equal to or higher than the first reference state (S240).

If the state of charge of the second battery 130 is lower than the first reference state, the controller 140 may control the second battery 130 to not supply power to the driving unit 17 and provide the driver with a notification indicating that the vehicle 100 may not be able (e.g., it is impossible) to respond to the requested output (S260).

When power supply of the second battery 130 is limited and the notification indicating that the vehicle may not be able (e.g., is impossible) to respond to the requested output is provided (e.g., after S260 is performed), the controller may control to maintain the normal driving situation of the vehicle by driving the driving unit 170 (e.g., only) with power of the first battery 110 (S230).

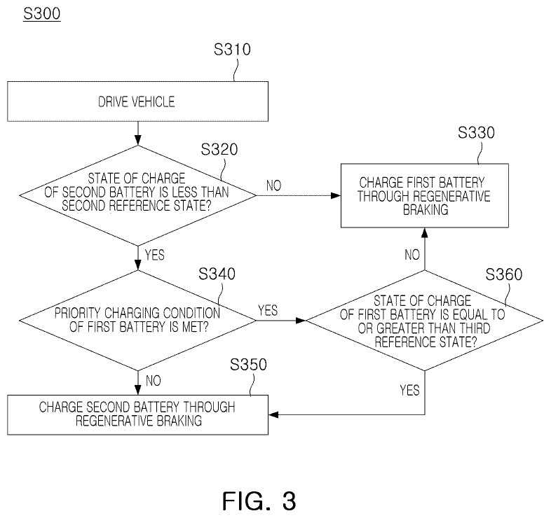

FIG. 3 is a flowchart of a control method of the vehicle 100 including the dual batteries 110 and 130 according to an embodiment of the present disclosure.

FIG. 3 illustrates a regenerative braking charging method (S300) of dual batteries that controls an operation of charging the first battery 110 and the second battery 130 in a regenerative braking state while the vehicle 100 is driving.

The operations included in the regenerative braking charging method (S300) of the dual batteries may be performed by at least some of the components (e.g., the first battery 110, the second battery 130, the controller 140, and the driving unit 170) included in the vehicle (e.g., the vehicle 100 of FIG. 1) described above with reference to FIG. 1.

Hereinafter, in describing FIG. 3, FIG. 1 will be referred to together and any redundant description will be omitted.

Referring to FIG. 3, a method (S300) for controlling charging of the dual batteries during regenerative braking of the vehicle 100 according to an embodiment may be configured to charge either the first battery 110 or the second battery 130 based on the state of charge of the first battery 110, the state of charge of the second battery 130, and whether the priority charging condition of the first battery 110 is met.

The controller 140 may control the first battery 110 to supply power to the driving unit 170 so that the vehicle 100 may be driven (S310).

Regenerative braking may be performed while the vehicle is driving. For example, regenerative braking may be performed when the driver steps on the brake or takes his/her foot off an accelerator pedal.

During regenerative braking, the controller 140 may determine whether the state of charge of the second battery 130 is less than a second reference state (S320).

Here, if the state of charge of the second battery 130 is less than the second reference state, it may indicate (e.g., mean) that the second battery 130 may need (e.g., needs) to be charged, and if the state of charge of the second battery 130 is greater than or equal to the second reference state, it may mean that the second battery 130 may (e.g., does) not need to be charged.

If the state of charge of the second battery 130 is greater than or equal to the second reference state, the controller 140 may control the first battery 110 to be charged by regenerative braking (S330).

When the state of charge of the second battery 130 is less than the second reference state, the controller 140 may determine whether the priority charging condition of the first battery 110 is met (S340).

Here, a case in which the priority charging condition of the first battery 110 is met may refer to a case in which the driver has set the first battery 110 to be charged preferentially by regenerative braking or a case in which a discharged amount (i.e., usage) of the second battery 130 during the past reference period is lower than the reference value. For example, when the driver has set the priority charging of the first battery 110 during regenerative braking, the controller 140 may charge the first battery 110 preferentially by regenerative braking even in the case that the state of charge of the second battery 130 is less than the second reference state. In addition, if the frequency of use of the second battery 130 is less than a reference value from the present to a point before a designated period, the controller 140 may charge the first battery 110 preferentially by regenerative braking even in the case that the state of charge of the second battery 130 is less than the second reference state.

The controller 140 may control the second battery 130 to be charged by regenerative braking if the priority charging condition of the first battery 110 is not met (S350).

The controller 140 may determine whether the state of charge of the first battery 110 is greater than the third reference state when the priority charging condition of the first battery 110 is met (S360).

Here, if the state of charge of the first battery 110 is less than the third reference state, it may mean that the first battery 110 may need (e.g., needs) to be charged, and if the state of charge of the first battery 110 is equal to or greater than the third reference state, it may mean that the first battery 110 may (e.g., does) not need to be charged.

For example, when the state of charge of the second battery 130 is less than the second reference state, the priority charging condition of the first battery 110 is met, and when the state of charge of the first battery 110 is equal to or greater than the third reference state, the controller 140 may control the second battery 130 to be charged by regenerative braking (e.g., S320, S340, S360, S350 are sequentially performed).

For example, when the state of charge of the second battery 130 is less than the second reference state, the priority charging condition of the first battery 110 is met, and when the state of charge of the first battery 110 is less than the third reference state, the controller 140 may control the first battery 110 to be charged by regenerative braking (e.g., S320, S340, S360, and S330 are performed sequentially).

Meanwhile, the regenerative braking charging method (S300) of the dual batteries illustrated in FIG. 3 is an example, and according to various embodiments, when the priority charging condition of the first battery 110 is met, the operation of determining whether the state of charge of the first battery 110 is greater than or equal to the third reference state may be omitted. For example, even in the case that the state of charge of the second battery 130 is less than the second reference state, if the priority charging condition of the first battery 110 is met, the controller 140 may control the first battery 110 to be charged by regenerative braking.

According to an embodiment of the present disclosure, an output of an electric vehicle may be efficiently controlled by selectively using the second battery of a high output density design in addition to the first battery of a high energy density design based on the requested output and the state of charge.

Although the embodiments of the present disclosure have been described in detail, the scope of the present disclosure is not limited thereto, and it is obvious to those skilled in the art that various modifications and variations may be made within the scope without departing from the technical idea of the present disclosure described in the claims.

In addition, some components of the embodiments of the present disclosure may be implemented in a state of being deleted, and the components of each embodiment may also be combined with each other to be configured.

What is claimed is:

1. A vehicle comprising:
a driving unit including a motor;
a first battery and a second battery provided to supply power to the driving unit; and
a controller controlling the first battery and the second battery,
wherein the controller controls the first battery to supply power to the driving unit in a normal driving situation in which a requested output corresponding to driving is lower than or equal to a maximum output of the first battery, and
controls the first battery and the second battery so that the second battery additionally supplies power to the driving unit together with the first battery in a high-output driving situation in which the requested output exceeds the maximum output of the first battery.

2. The vehicle of claim 1, wherein the controller is configured to allow or limit power supply of the second battery to the driving unit based on a state of charge of the second battery in the high-output driving situation.

3. The vehicle of claim 2, wherein the controller controls the second battery to supply power to the driving unit when the state of charge of the second battery is equal to or greater than a first reference state.

4. The vehicle of claim 3, wherein the controller restricts the supply of power from the second battery to the driving unit and provides a driver with a notification indicating that the vehicle may not be able to respond to the requested output, when the state of charge of the second battery is lower than the first reference state.

5. The vehicle of claim 1, wherein the first battery is configured based on a high energy density cell design, and the second battery is configured based on a high output density cell design.

6. The vehicle of claim 1, wherein the first battery has a higher capacity than the second battery.

7. The vehicle of claim 1, wherein the first battery is provided to be charged using power supplied from an external source.

8. The vehicle of claim 1, wherein the first battery is able to supply power to the second battery, and the second battery is charged through power supplied from the first battery.

9. The vehicle of claim 1, wherein the first battery and the second battery are provided to be charged by regenerative braking.

10. The vehicle of claim 9, wherein the controller controls one of the first battery and the second battery to be charged by regenerative braking based on a state of charge of the second battery in a regenerative braking state.

11. The vehicle of claim 10, wherein the controller is configured to charge the second battery through regenerative braking when the state of charge of the second battery is less than a second reference state and to charge the first battery through regenerative braking when the state of charge of the second battery is equal to or greater than the second reference state.

12. The vehicle of claim 11, wherein the controller determines whether a priority charging condition of the first battery is met when the state of charge of the second battery is less than the second reference state, and when the priority charging condition is met, the controller is configured to charge the first battery through regenerative braking even if the state of charge of the second battery is less than the second reference state.

13. The vehicle of claim 12, wherein a case in which the priority charging condition is met is one of a state in which a driver sets the first battery to be charged first or a state in which a discharged amount of the second battery is equal to or less than a reference value during a reference date.

14. The vehicle of claim 12, wherein the controller determines whether to charge the first battery through regenerative braking based on a state of charge of the first battery when the priority charging condition is met.

15. The vehicle of claim 14, wherein the controller is configured to charge the first battery through regenerative braking when the state of charge of the first battery is less than a third reference state and to charge the second battery through regenerative braking when the state of charge of the first battery is equal to or greater than the third reference state even if the priority charging condition is met.
